(19) United States
(12) Patent Application Publication
(10) Pub. No.: US 2004/0196142 A1
(43) Pub. Date: Oct. 7, 2004

(54) PAGING REMOTE DISCONNECT SYSTEMS

(75) Inventor: Eric P. Berg, Thornton, CO (US)

Correspondence Address: WEBB LEWIS & MEYERS LLC, 2300 15TH STREET, SUITE 320, DENVER, CO, 80202, US

(73) Assignee: PEREGRINE CONTROL TECHNOLOGIES DBA NIGHTHAW, INC., Denver, CO (US)

(21) Appl. No.: 10/709,442

(22) Filed: May 5, 2004

Related U.S. Application Data
(63) Continuation of application No. 09/910,414, filed on Jul. 20, 2001, now abandoned.
Application No. 09/910,414 is a continuation-in-part of application No. 09/672,162, filed on Sep. 27, 2000, now abandoned.

(51) Int. Cl. H04Q 7/00

(52) U.S. Cl. 340/7.1; 340/7.54; 379/102.04; 455/66.1; 455/68

(57) ABSTRACT

A wireless remote control system within a power supply or telecommunications module. A user simply plugs the power cord or telecommunication line of their device, such as a computer or appliance, into the outlet of the module. The user is then able to dial a pager number that is already pre-programmed. The paging service then transmits a signal to a radio frequency (“RF”) receiver in the module. The signal is then decoded and sent to a processor. The processor then causes a relay to open or close in accordance with the decoded signal to activate the power supply or to turn the power off to the electronic device or to connect or disconnect the telecommunications line.

### BACKGROUND OF INVENTION

The use of electronic and electrical devices is prevalent in most people's lives, both in the workplace and in their personal life. These devices are typically controlled by manual power switches to turn the devices off and on as needed. A few devices use automatic controls, such as thermostats. However, most such devices used in the home and in the workplace are powered up and down by manual switches. A problem frequently arises in the need to power a device on or off while the user is not on the premises. For example, a user may have inadvertently left a device, such as a computer or appliance operating, or else was forced to leave the device powered up to finish a task. The user may not want to leave this device powered up indefinitely, due to security, safety or other concerns. Other examples may include safety concerns, such as household appliances, commercial devices, etc. Previously, the only solution available to the user is to return to the site and turn the device off. This is a waste of the user's time and effort.

Another scenario that may arise as well is the need to turn a device on. For example, a user may need to power a remote computer on in order to accomplish a task, retrieve data, or transmit a message. Other examples include the desire to turn a hot tub or spa on so to be ready when the user arrives, turn a heater or air conditioner on, turn lighting systems on, turn a remote device on, or almost any other electrical and/or electronic device on.

Another problem that exists presently is unauthorized usage or attacks on telephones or other telecommunication devices. There currently is no mechanism for disconnecting or connecting telephones from a remote external source. Thus, previously the only way to prevent an unauthorized user from accessing a telephone line is to physically disconnect the line at the device. This may be a particular problem in situations where a remote site is only occasionally used, such as a vacation cabin, a rental apartment, or other locations that may be intermittently used or used by others.

Another area of concern lies with the use of telecommunication devices. Many devices currently utilize telecommunications as a means for receiving, transmitting and sharing information. These can include telephone, ISDN, DSL and variations on these devices, cable modems, network connections, radio frequency devices, cellular devices, infrared devices, and other wireless connections and any other type of communicating between devices. Presently, some users install firewalls for protection against unauthorized entry. However, these have limited effectiveness at best, and may not be suitable in many situations. Thus, the ability to protect against unauthorized access to these types of communications is of great importance at present.

Presently there are no solutions that will solve these problems of remotely turning devices on or off and of remotely preventing unauthorized access of telecommunication and network devices. One attempt at remotely powering devices on and off is disclosed in U.S. Pat. No. 5,608,655, issued to Moughanni et al. This patent discloses the use of a paging communication device installed directly within an electronic device to operate the electronic device. Circuitry is installed and connected within the electronic device to allow a paging signal to be transmitted to the communication device wired to the electronic device. The paging signal is received, decoded to a paging bit stream signal and conducted to a serial peripheral interface. The serial peripheral interface is coupled to a control register, a central processing unit, a memory and command processing unit (“CPU”). The CPU then determines whether the signal is a message or command. If a command is received, then the CPU sends a command signal to a security encoder. The command signal is then transmitted to the electronic device for execution.

This device requires direct installation within the device being controlled and a hard connection to the device to be controlled. Additionally, the communication device and the electronic device to be controlled must be programmed to interoperate. This is beyond the realm and cost of most users. Thus, this device is not used as discussed above. Further this device is limited to use with electronic devices.

Presently, there is a need for a device that will enable remote operation of electronic devices, electrical connections and/or telecommunication and network connection in a simple, inexpensive and in plug and play operation without the need for expensive direct installation and programming.

### SUMMARY OF INVENTION

The present invention solves these problems and others by providing a system for remote disconnect/connection of electrical and/or telephonic devices. The system, in a preferred embodiment, is a “plug and play” device that is already preprogrammed for operation. The user simply plugs in the power cord or telephone line (and in other embodiments, such lines as a network cable, coaxial cable, or other telecommunications lines) into the outlet side of the device of the present invention. Power or telephone service is provided by plugging in the power cord and/or telephone line of the remote operation device into a wall outlet or other source. Once the paging service has been activated, the system is ready for operation without the need of complicated installation or programming. The user is then able to dial a pager number that is already pre-programmed. The paging service then transmits a signal to a radio frequency (“RF”) receiver in the power supply module. The signal is then decoded and sent to a processor. The processor then causes a switching circuit to open or close in accordance with the decoded signal to activate the power supply or to turn the power off to the electronic device. The exemplary embodiments are described using relay switches or other types of switching circuits.

The entire system is incorporated into an enclosure and can be purchased in an “off-the-shelf” manner. The system can either be designated as a power-off device, a power-on device or a combination of the two. Thus the user can easily turn devices on or off remotely as desired. Multiple power outlets can be incorporated in the enclosure as well that can be simultaneously powered on or off or individually controlled.

Another important feature in another preferred embodiment is to prevent unauthorized access to telephone devices. Unauthorized use can be prevented in the use of telephones in remote locations. This embodiment has particular use in remote vacation homes, offices, rental properties and other locations where usage is only needed intermittently or where unauthorized usage may be a problem. The telephone line can be disconnected remotely and reconnected when needed from an external remote location.

As discussed above, the telephone is connected to the supply module, which can be located in a secure location, such as an enclosure, cabinet or closet. The user can simply dial a telephone number that causes a paging signal to be sent to the module. The signal is received, decoded and sent to the command processor. The processor then causes a switching circuit to open or close the telephone circuit, as desired to allow the telephone device to be accessible or not. Thus access to the telephone device can be controlled externally by remote operation.

Another embodiment of the present invention prevents unauthorized use in telecommunication devices. Telecommunications is critical in the exchange of information via networks, modems, cable modems and other types of transmission. This embodiment has particularly utility in preventing unauthorized access to information and devices connected via such connections. The user can remotely turn on the switch between an inlet telecommunications source and the telecommunicating device (such as computers, servers, remotely operated devices, and others) for a limited time. The user can then remotely cause the switch to open to interrupt the transmission to the device. Thus, unauthorized access to these devices is prevented while allowing one or more remote users access as needed. This becoming an increasingly important concern.

These and other features will be evident from the ensuing description of preferred embodiments and from the drawings.

### BRIEF DESCRIPTION OF DRAWINGS

FIG. 1 illustrates a view of a preferred embodiment of the present invention.

FIG. 2 shows a device utilizing the preferred embodiment of FIG. 1.

FIG. 3 illustrates in block diagram the system of the preferred embodiment of FIG. 1.

FIG. 4 illustrates a schematic of the RF receiver, and filter of the preferred embodiment of FIG. 1.

FIG. 5 illustrates a schematic of the decoder circuit of the embodiment of FIG. 1.

FIG. 6 illustrates a command controller unit of the preferred embodiment of FIG. 1.

FIG. 7 illustrates a schematic of the switching circuit, input power supply unit, the output power supply unit, the telephone switching circuit, input telephone supply and output telephone supply of the preferred embodiment of FIG. 1.

### DETAILED DESCRIPTION

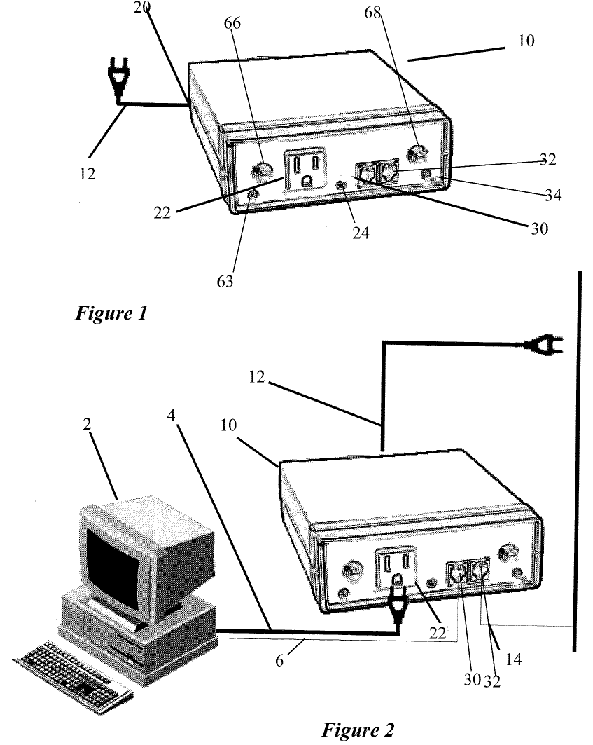

A preferred embodiment of the present invention is illustrated in FIGS. 1-7. It is to be expressly understood that the descriptive embodiments are provided herein for explanatory purposes only and is not meant to unduly limit the claimed inventions. The preferred embodiment of the present invention includes a wireless remote control system to control the operation of electronic, telephonic and other devices. In the preferred embodiment illustrated in FIGS. 1-7, the wireless remote control system includes plug-n-play operation, eliminating the need for incorporation of the controls within the devices as well the need to program the devices for operation. This preferred embodiment allows a user to simply plug their devices into the power outlet incorporated with the system or into the telephone outlet. The user is not required to modify their devices to use this system.

General Overview

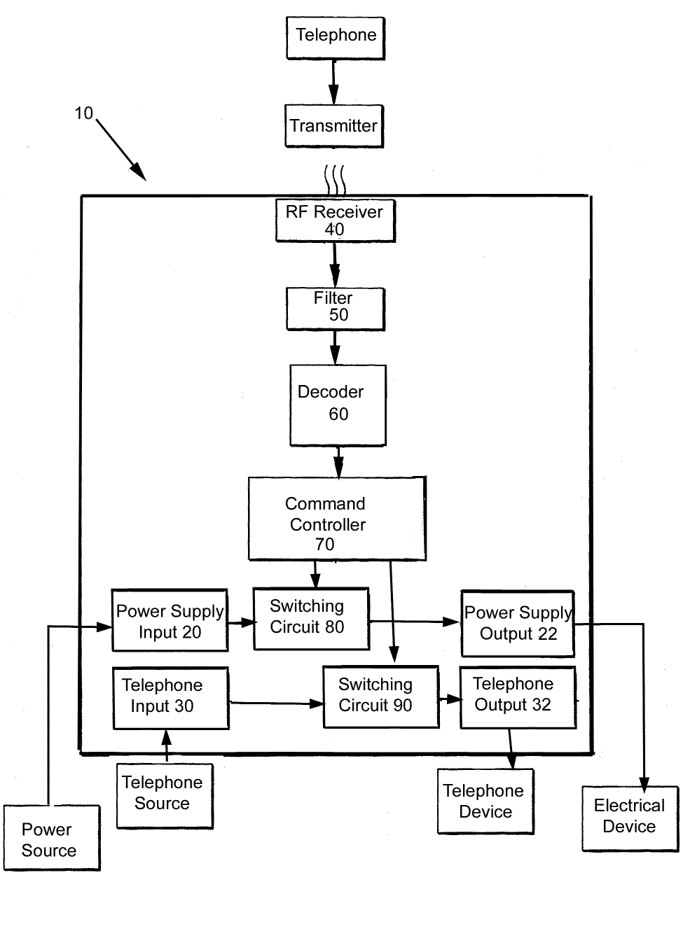

In a preferred embodiment, the present invention incorporates a wireless remote control system within a power supply and telephone supply module 10, as shown in FIG. 1. A user simply plugs the power cord 4 of their electronic device, such as a computer 2, into the outlet 22 of the power supply module 10 as shown in FIG. 2. A telephone line 6 coming from a telephone or computer modem is also plugged into the telephone outlet 32 of the module 10 as well. The user is then able to dial a pager number that is already pre-programmed. The paging service then transmits a signal to a radio frequency (“RF”) receiver in the power supply module. The signal is then decoded and sent to a processor. The processor then causes a relay to open or close in accordance with the decoded signal to activate the power supply or to turn the power off to the electronic device. Also, a signal may be sent to disconnect the telephone line or to reconnect the telephone line. The exemplary embodiments are described using relay switches. It is to be expressly understood that other types of switching circuits or control devices can be used as well to interrupt and close the transmission of electrical power, telephone signals or other signals as described below.

In the preferred embodiment, the present invention includes module 10 having an electrical power supply unit and telephone connection unit. The electrical power supply unit, as shown in FIGS. 1 and 2, includes an electrical power cord 12 with a standard plug for connection into a standard electrical outlet. The power cord 12 connects to module 10 that includes at least one electrical outlet 22. As shown in FIG. 2, the power cord 12 plugs into a surge protector, wall outlet or other outlet. The computer or other electronic device plugs into the electrical outlet 22 of the module 10. Likewise, a telephone line connects from a standard wall outlet to telephone input 30 of module 10. A telephone, computer modem, answering machine or other telephonic device then connects via a standard telephone line 6 to the telephone outlet 32 on the module 10. In the preferred embodiment, the module 10 is contained within an enclosure that does not need to be accessed by the user to operate the system.

It is to be expressly understood that while the descriptive embodiment is illustrated with the combination of an electrical supply and a telephone connection, that other embodiments using either the electrical supply or telephone connection could be used as well under the scope of the claimed inventions. Also, it is to be expressly understood that multiple electrical outlets and/or telephone outlets can be used as well that can be controlled simultaneously or individually. Various combinations of the electrical supplies and telephone connections can be used also.

The remote disconnection/connection system of a preferred embodiment is shown in an operational diagram in FIG. 3. The system 10 includes Input Power Supply 20, Input Telephone Supply 30, Radio Frequency (“RF”) Receiver 40, Filter Circuit 50, Decoder Unit 70, Command Controller Unit 70, Electrical Switching Circuit 80, Electrical Output Power Supply 22, Telephone Switching Circuit 90 and Telephone Output 32. Each of these circuits will be discussed in greater detail below.

In use, power is supplied to the system via the input power supply unit. The power supply input 20, in the preferred embodiment receives 110/220 volt through a power cord 12 that can be plugged into a standard electrical outlet or else wired permanently. It is to be expressly understood that other types of power can be used as well. The device to be controlled is plugged into the main power output 80 that, in the preferred embodiment, is a standard electrical outlet. In the preferred embodiment, the main power outlet 32 is “hot”, meaning that electrical current is available. An LED 26 on the exterior of the box 10 of the system glows to signal that the outlet is hot. It is to be expressly understood that the main power output 80 can also be set to be initially in a powered down state. The descriptive embodiment is using the initial powered up state for explanatory purposes only. A toggle switch 28 is provided on the face of the module to allow the use to switch the outlet on or off manually. The switching circuit, in the preferred embodiment, is enabled in a failsafe mode.

If the user then decides to remotely power down the device, it only requires a simple telephone call. The user calls an assigned telephone number to a paging service. The user may also use a mobile telephone, a personal computer, or even a personal digital assistant. The paging service then transmits an encrypted signal from a paging transmitter in accordance with standard paging technology. The signal can be transmitted from land or satellite based paging transmitters.

The paging signal is received at the system 10 by RF receiver 40. The system may use an external antennae if necessary. The received paging signal is then filtered through filter circuit 50 and sent to decoding controller 60. The controller 60 then decodes the signal into a command stream. This command stream is sent to the Command Controller Unit 70.

The Command Controller Unit 70, in accordance with the command stream, then activates the Electrical Switching Circuit 80. Electrical Switching Circuit 80, in the preferred embodiment, is a relay switch. It is to be expressly understood that other types of circuits may be used as well to enable the switching operation. The Electrical Switching Circuit 80 is normally in the closed position so that the fail mode is powered on in the preferred embodiment. In this embodiment the Circuit 80 is in a closed position so the main power output is hot. Thus, the Command Controller Unit 70, upon receiving the command signal processed from the signal sent by the paging transmitter based on the user's call, causes the Electrical Switching Circuit 80 to open. The current from the input power unit is interrupted and the main power output 22 is no longer hot. The device that is plugged into the main power output 22 is now powered down.

It is to be expressly understood that the reverse can also be accomplished under the present invention. The Switching Circuit 80 may be maintained normally in the open position so that power is not initially powered to the main power output 22. The user can then power up any device connected to the main power output 22 by simply paging the system, as discussed above. The Electrical Switching Circuit 80 is closed to allow current to flow to the main power output 22 to power up the device connect to it.

Multiple power outputs can also be connected in the system of this preferred embodiment. This allows various devices to be powered up or down, either simultaneously, or individually.

In the preferred embodiment, the Command Controller Unit 70 is also able to send a signal to Telephone Switching Circuit 90. The Circuit 90, which also is a relay circuit in the preferred embodiment, operates to open or close a telephone connection between Telephone Input 30 and Telephone Output 32. In this embodiment, the Relay Circuit interrupts a telephone line. A line 14 connects the Telephone Input 30 to a standard telephone supply, such as a wall outlet. A telephone device, such as a telephone, answering machine, computer modem or other telephone device is connected by line 6 to Telephone Output 32. LED 34, on the outside of module 10, indicates the state of the Circuit 90. Toggle Switch 36 allows the user to manually switch the state of the Circuit 90. The user is able to open or close the Telephone Switching Circuit 90 by dialing a telephone number to send a paging signal to RF Receiver 40 that is filtered by Filter 50 and decoded by Decoder controller 60. The decoded signal is then processed by Command Processor 70 that sends the signal to Telephone Switching Circuit 90 to open or close the telephone connection.

In the preferred embodiment, either separate telephone numbers can be used to control the Electrical Switching Circuit 80 and Telephone Switching Circuit 90, or a single telephone number can be used with a menu to select the appropriate Circuit to be controlled.

In an alternative embodiment, a network connection can be controlled in a similar fashion. The network connection, such as an Internet connection, or external LAN, WAN, MAN, Intranet, or other network connections are connected via a module of the present invention. This module would include a switching circuit capable of interrupting the network connection, in a manner as discussed above. A user is able to send a telephone signal to transmit a paging signal to the module to open or close the network connection. This embodiment is particularly useful in network connections to prevent unauthorized hacking into a network from an outside attack. The switching circuit can be remotely opened to allow access to the network, or even an individual computer, by an authorized user. Once the access is ended, then the user can interrupt the telephone circuit remotely to prevent others from hacking in over that line. This has particular utility for networks that contain sensitive information or that may be vulnerable to attacks. It provides a “hardware” solution to prevent unauthorized access to computers and/or networks.

Specific Implementation of a Wireless Remote Control System

A specific implementation of a wireless remote control activation system, as discussed above, is shown in FIGS. 1-7. It is to be expressly understood that this implementation is being described for explanatory purposes and is not meant to limit the claimed inventions.

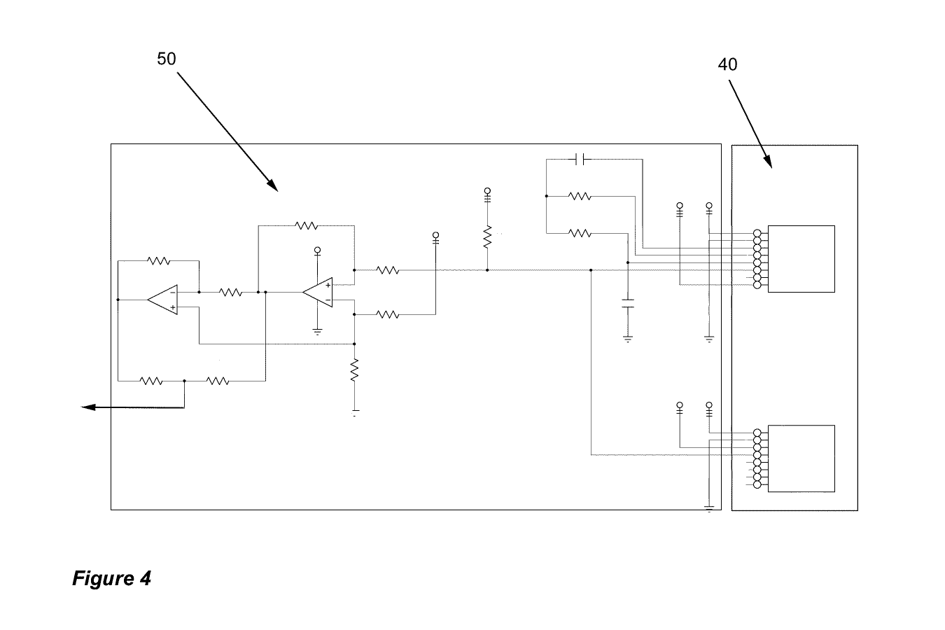

The paging remote disconnect system 10 includes an enclosure as shown in FIGS. 1 and 2, having a power cord 12 that connects to the power supply input unit 20. In this preferred embodiment, the power supply input unit is 110/220 volts AC, but in other embodiments, other power ranges could be used or the power supply input could be transformed to a desired voltage. A logic circuit board (not shown) is mounted within the enclosure. A flow chart of the operation of the logic circuit board is illustrated in FIG. 3. Schematics of the logic circuit board are illustrated schematically in FIGS. 4-7.

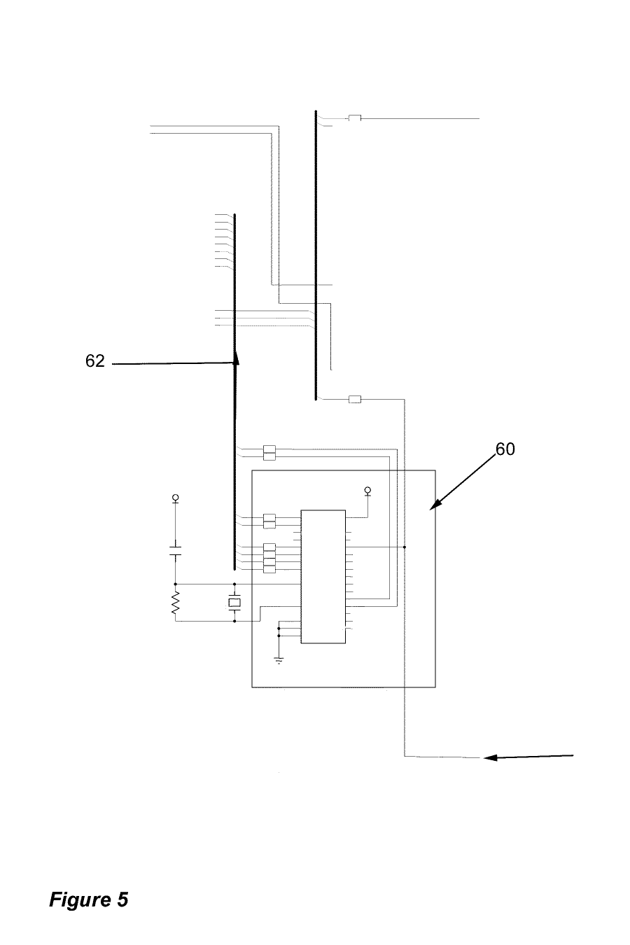

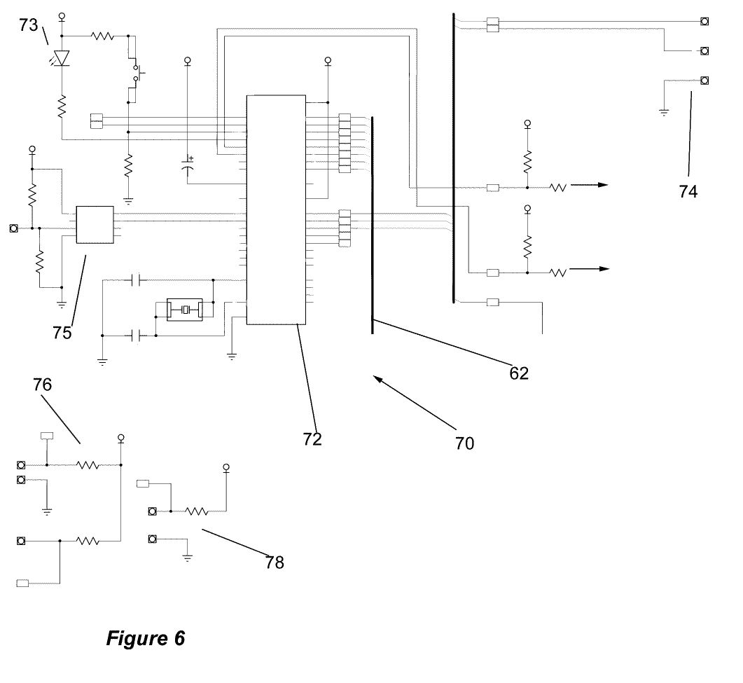

RF Receiver 40 is schematically shown in FIG. 4. The RF Receiver 40 is capable of receiving an RF signal from a paging transmitter (not shown). The paging transmitter can be land-based or satellite based. The RF Receiver 40 may be connected to an external antenna (not shown) if necessary. The paging transmitter transmits the RF signal based upon a user telephoning an assigned telephone number, or from a computer via a modem, personal digital assistant or other known devices for notifying the paging transmitter. The RF Receiver 40 receives the RF signal from the paging transmitter wherein it is sent through Filter 50 to initially process the signal. The filtered signal is then sent to Paging Decoder 60, shown in FIG. 5, that decodes the RF signal from a typical paging protocol format. The transmitted signal is decoded into a digital bit stream and sent onward along buss 62 to the Command Controller 70, shown in FIG. 6.

Command Controller 70 receives the digital bit stream and acts in accordance with the information contained in the stream. The Command Controller 70 includes an integrated processor circuit 72 to process the signal. Controller Unit 70 may also includes an LED (Light Emitting Diode) 73 to display the status of the Unit. A message may also be displayed in one preferred embodiment of the present invention by sending the message via a serial interface 74 to a monitor, printer or other device. The serial interface 74 also allows the Command Controller Unit 70 be updated or reprogrammed. The Unit 70 also includes a buffer memory circuit 75 in the event that the Controller Unit memory bank is full.

Power Override Circuit 76 is provided to allow the Command Controller Unit 70 to be overridden, such as to manually switch the power on or off to the Power Supply Output 22. Also, Telephone Override Circuit 78 allows the Unit to be overridden to manually switch the Telephone Output 32 on or off.

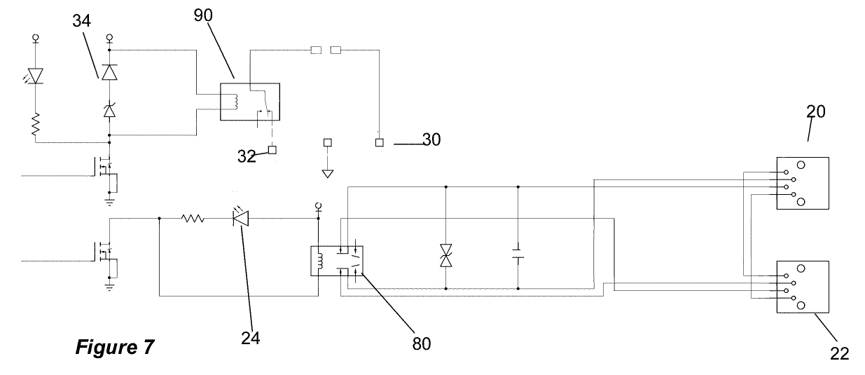

In normal use, the Command Controller Unit 70 transmits a command signal to the Power Supply Switching Circuit 70, shown in FIG. 7, in accordance with the paging transmitted signal. The Switching Circuit 80, normally held in the closed position would then be reset to the open position to prevent power from flowing to Power Supply Output 22. Thus, any electrical devices connected to the Power Supply Output 22 would then be powered down. Alternatively, if the failsafe mode is in the open position, then the Switching Circuit 80 would then be closed to allow power to flow to the Power Supply Output 22 to power up any electrical devices connected to the Power Supply Output 22. In this preferred embodiment, Switching Circuit 80 is a relay switch, but other types of switching circuits could be used as well.

In another preferred embodiment, multiple Output Power Supplies may be used to power a plurality of devices. These Output Power Supplies may be controlled by a single Relay Switch to simultaneously power down all of the Output Power Supplies or multiple Relay Switches may be used, each controlled by a different signal from the Command Control Unit to operate the Output Power Supplies individually.

Signals are also transmitted to Telephone Switching Circuit 90 connected between the Telephone Input 30 and Telephone Output 32. This Circuit 90 is also normally held in the failsafe closed mode in the preferred embodiment. The Circuit 90 opens upon the signal from the Command Unit 70 to break the connection and prevent access to the telephone line. The connection can be reset upon the Telephone Switching Circuit receiving an appropriate signal from the Command Unit 70. Thus access between the telephone, modem, or other telecommunications device can be controlled. This is particularly useful in the event that a user desires to allow intermittent access to a telephone device.

In yet another alternative embodiment, the system can be used to control access to a network communications line, coaxial cable or other communications line. An appropriate switching circuit can be activated and deactivated to open and close the circuit to allow communications through the line. Remote users can activate the system to close the switching circuit to allow communications and open the switching circuit to prevent communications. It is to be expressly understood that other embodiments may also be within the scope of the present invention to allow signals, power and other transmissions to be controlled by wireless remote control in a plug and play operation without the need to directly install these devices integrally with the device to be controlled.

1. A system for remote operation of devices, said system comprising:
an input electrical supply source;
an output electrical outlet;
a switching circuit connected between said input electrical supply source and said output electrical outlet;
a receiver for receiving control signals from a remote source; and
a processor for processing said control signals from said receiver to open said switching circuit to interrupt electrical power transmission between said input electrical supply source and said output electrical outlet.

2. The system of claim 1 wherein said receiver includes:
a radio frequency receiver for receiving wireless radio frequency signals from a paging transmitter.

3. The system of claim 2 wherein said system further includes:
a decoder processor to decode the signal received from said radio frequency receiver from said paging transmitter into a control signal for said processor.

4. The system of claim 1 wherein said system further includes:
an enclosure; and
said output electrical outlet; said processor and said receiver are mounted within said enclosure.

5. The system of claim 1 wherein said input electrical supply source includes:
a power cord; and
a plug-in for insertion in a standard electrical wall outlet.

6. The system of claim 1 wherein said output electrical outlet includes:
a standard electrical outlet for receiving a standard plug-in from a power cord of an electrical device.

7. The system of claim 1 wherein said system includes:
a plurality of output electrical outlets.

8. The system of claim 1 wherein said system includes:
an input telephone source for receiving a telephone signal;
an output telephone outlet;
a telephone switching circuit mounted between said input telephone source and said output telephone outlet; and
said telephone switching circuit is operable under command signals from said processor based on signals received from said receiver to interrupt and connect signal transmission between said input telephone source and said output telephone outlet.

9. The system of claim 1 wherein said processor further includes:
means for sending a message to be displayed on a display device.

10. The system of claim 1 wherein said system further includes
an input telecommunications source;
an output telecommunications outlet;
a switching circuit connected between said input telecommunications source and said output telecommunications outlet; and
said switching circuit opens and closes the connection between said input telecommunications source and said output telecommunications outlet in accordance with signals from said processor.

11. A system for remote operation of devices, said system comprising:
an input electrical supply source;
an output electrical outlet;
a power switching circuit connected between said input electrical supply source and said output electrical outlet;
an input telephone source;
an output telephone outlet;
a telephone switching circuit connecting said input telephone source and said output telephone outlet;
a radio frequency receiver for receiving paging control signals from a paging transmitter; and
a processor for processing said control signals from said receiver to open said power switching circuit to interrupt electrical power transmission between said input electrical supply source and said output electrical outlet and to open said telephone switching circuit to disconnect the telephone connection between said input telephone source and said output telephone outlet.

12. The system of claim 11 wherein said system further includes:
a decoder processor to decode the signal received from said radio frequency receiver from said paging transmitter into a control signal for said processor.

13. The system of claim 11 wherein said system further includes:
an enclosure; and
said output electrical outlet; said telephone outlet; said processor and said receiver are mounted within said enclosure.

14. The system of claim 11 wherein said input electrical supply source includes:
a power cord; and
a plug-in for insertion in a standard electrical wall outlet.

15. The system of claim 11 wherein said output electrical outlet includes:
a standard electrical outlet for receiving a standard plug-in from a power cord of an electrical device.

16. The system of claim 11 wherein said system includes:
a plurality of output electrical outlets.

17. The system of claim 1 wherein said processor further includes:
means for sending a message to be displayed on a display device.

18. The system of claim 1 wherein said system further includes
an input telecommunications source;
an output telecommunications outlet;
a switching circuit connected between said input telecommunications source and said output telecommunications outlet; and
said switching circuit opens and closes the connection between said input telecommunications source and said output telecommunications outlet in accordance with signals from said processor.

19. The system of claim 1 wherein said system further includes:
an enclosure; and
said output telecommunication outlet; said processor and said receiver are mounted within said enclosure.

20. A system for remote operation of devices, said system comprising:
an input telephone source;
an output telephone outlet;
a telephone switching circuit connecting said input telephone source and said output telephone outlet;
a radio frequency receiver for receiving paging control signals from a paging transmitter; and
a processor for processing said control signals from said receiver to open said telephone switching circuit to disconnect and connect the telephone connection between said input telephone source and said output telephone outlet.

21. The system of claim 20 wherein said system further includes:
a decoder processor to decode the signal received from said radio frequency receiver from said paging transmitter into a control signal for said processor.

22. The system of claim 20 wherein said system further includes:
an input electrical supply source;
an output electrical outlet;
a power switching circuit connected between said input electrical supply source and said output electrical outlet; and
said processor opens said power switching circuit to interrupt and reconnect the power supply between said input electrical supply source and said output electrical outlet in accordance with signals received from said paging transmitter.

23. The system of claim 11 wherein said system further includes:
an enclosure; and
said output electrical outlet; said telephone outlet; said processor and said receiver are mounted within said enclosure.

24. The system of claim 11 wherein said input electrical supply source includes:
a power cord; and
a plug-in for insertion in a standard electrical wall outlet.

25. The system of claim 11 wherein said output electrical outlet includes:
a standard electrical outlet for receiving a standard plug-in from a power cord of an electrical device.

26. The system of claim 11 wherein said system includes:
a plurality of output electrical outlets.

27. The system of claim 1 wherein said processor further includes:
means for sending a message to be displayed on a display device.

28. A method for remote control of an electrical device using a system having an input electrical supply source;
an output electrical outlet; a switch connected between said input electrical supply source and said output electrical outlet; a receiver for receiving control signals from a remote source; and a processor for processing said control signals from said receiver to open said switch to interrupt electrical power transmission between said input electrical supply source and said output electrical outlet, said method comprising the steps of:
connecting the electrical device to be controlled to said output electrical outlet;
transmitting a paging signal to said receiver from a remote paging transmitter in accordance with a page from a remote user;
sending said transmitted signal to said processor for relaying a command signal to said switch; and
operating said switch in accordance with said command signals from said processor to interrupt and connect the connection between said input electrical source and said output electrical outlet to control the power to the electrical device.

29. A method for remote control of an telecommunication device using a system having an input telecommunication supply source; an output telecommunication outlet; a switch connected between said input telecommunication supply source and said output telecommunication outlet; a receiver for receiving control signals from a remote source; and a processor for processing said control signals from said receiver to open said switch to interrupt telecommunication power transmission between said input telecommunication supply source and said output telecommunication outlet, said method comprising the steps of:
connecting the telecommunication device to be controlled to said output telecommunication outlet;
transmitting a paging signal to said receiver from a remote paging transmitter in accordance with a page from a remote user;
sending said transmitted signal to said processor for relaying a command signal to said switch; and
operating said switch in accordance with said command signals from said processor to interrupt and connect the connection between said input telecommunication source and said output telecommunication outlet to control the transmission to the telecommunication device.
